(19) United States
(12) Patent Application Publication
(10) Pub. No.: US 2014/0268702 A1
(43) Pub. Date: Sep. 18, 2014

(54) STRUCTURE OF CANDLE WITH FAUX ICE CRACK PATTERN

(71) Applicant: CHIN-SHENG YANG, Tainan City (TW)

(72) Inventor: CHIN-SHENG YANG, Tainan City (TW)

(21) Appl. No.: 13/802,745

(22) Filed: Mar. 14, 2013

(51) Int. Cl. F21V 11/00; F21L 4/02

(52) U.S. Cl. CPC F21V 11/00; F21L 4/02
USPC 362/184

(57) ABSTRACT

A structure of candle with faux ice crack pattern includes: a main base body, having power source part providing connection to battery for power; a light-emitting unit, having two light-emitting elements, with one placed separately above the other, light-emitting unit disposed on top of main base body and electrically connected to power source part; a pattern film, transmittable, surface having grid pattern formed by laser etching, and housed inside a shell; a shell, a hollow transparent shell, with one end having an opening, outer surface of shell having ice crack pattern, and engaged to main base body. As such, the light of light-emitting unit projects grid pattern on pattern film onto the shell to form crisscross pattern with ice crack pattern on outer surface of shell so that the shell can display separate color, grid and difference shades of luminance to achieve the visual effect of faux ice crack.

### (a) TECHNICAL FIELD OF THE INVENTION

The present invention generally relates to a structure of candle with faux ice crack pattern, and more particularly to a structure of candle with faux ice crack pattern, able to project the pattern in the inner layer by light onto the ice crack pattern on the shell.

### (b) DESCRIPTION OF THE PRIOR ART

Candle is one of the oldest lighting devices. As a variety of lighting devices is developed, the candle is mostly used in creating an ambience, festive events and religious ceremonies. The candles used above are mostly in the shape of a stick, with little variations.

On the other hand, an electronic candle is developed to replace the conventional candle to avoid potential danger. While the electronic candle can both laminate and decorate, manual work is often required to glue colorful pieces to achieve the visual effects of ice crack, grids and separate colors to display the aforementioned ice crack pattern, which is inconvenient and time-consuming. Therefore, it is desirable to devise an electronic candle with a visual effect of faux ice crack pattern on the shell.

### SUMMARY OF THE INVENTION

The primary object of the present invention is to provide a structure of candle with faux ice crack pattern, including: a main base body, having a power source part, the power source part providing connection to a battery for obtaining power; a light-emitting unit, having two light-emitting elements, with one placed separately above the other, the light-emitting unit being disposed on the top of the main base body, and electrically connected to the power source part; a pattern film, being transmittable, with surface having a grid pattern formed by laser etching, being housed inside a shell; a shell, being a hollow transparent shell, with one end having an opening, the outer surface of the shell having an ice crack pattern, and engaged to the main base body.

As such, the light from the light-emitting unit is used to project the grid pattern on the pattern film onto the shell to form crisscross pattern with the ice crack pattern on the outer surface of the shell so that the shell can display separate color, grid and difference shades of luminance to achieve the visual effect of faux ice crack.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a schematic view according to the invention.

FIG. 2 shows a dissected view according to the invention.

FIG. 3 shows a cross-sectional view according to the invention.

FIG. 4 shows a schematic view from a lower angle according to the invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIGS. 1-3, which are schematic view, dissected view and cross-sectional view of the present invention, respectively, the structure of candle with faux ice crack pattern includes: a main base body 1, having a power source part 11, the power source part 11 providing connection to a battery for obtaining power, a fixing trench 12 being disposed on the main base body 1, and a bottom cover 13 being disposed to engage at the bottom of the main base body 1; a light-emitting unit 2, including at least a primary light-emitting element 21, at least a secondary light-emitting element 22 and a circuit board 23, the primary light-emitting element 21 and the secondary light-emitting element 22 being placed separately with one above the other, and being disposed on a column 24, the column 24 being engaged to fixing trench 12 of the main base body 1, the circuit board 23 being electrically connected to the power source part 11 of the main base body 1, and able to control the primary light-emitting element 21 and the secondary light-emitting element 22; a pattern film 3, being transmittable, with surface having a grid pattern 31 formed by laser etching, being housed inside a shell 4, the pattern film 3 being made of soft light-transmittable plastic film; a shell 4, being a hollow transparent shell 4, with one end having an opening 41, the outer surface of the shell having an ice crack pattern 42, the ice crack pattern 42 being directly molded from plastic material or by applying chemical on the injection mold product, and the shell 4 being engaged to the main base body 1.

Referring to FIG. 4, in the present embodiment, the main base body 1 is further disposed with a switch 14, with one end connected to the power source part 11 and the other end connected to the circuit board 23. The switch 14 is for controlling the ON and OFF of the primary light-emitting element 21 and the secondary light-emitting element 22. The top of the shell 4 is disposed with a hole 44 and the primary light-emitting element 21 is disposed at the tip of the column 24 and partially extends beyond the hole 44 to expose. The hole 44 allows the disposition of a shade 5. The shade 5 is hollow and has a candle shape. In the present embodiment, the secondary light-emitting elements 22 are color LED, and the circuit board 23 controls the luminance order and timing of the secondary light-emitting elements 22 so as to use the light from the secondary light-emitting elements 22 projected onto the pattern film 3 to further project the grid pattern 31 of the pattern film 3 onto the shell 4 to form a crisscross effect with the ice crack pattern 42 on the outer surface of the shell 4. As such, the shell 4 can display different shades of luminance with effects of grid, separate color and ice crack patterns to enhance esthetics as a ambient light source.

It will be understood that each of the elements described above, or two or more together may also find a useful application in other types of methods differing from the type described above.

While certain novel features of this invention have been shown and described and are pointed out in the annexed claim, it is not intended to be limited to the de ails above, since it will be understood that various omissions, modifications, substitutions and changes in the forms and details of the device illustrated and in its operation can be made by those skilled in the art without departing in any way from the spirit of the present invention.

I claim:

1. A structure of candle with faux ice crack pattern, comprising:
a main base body, having a power source part, the power source part providing connection to a battery for obtaining power;
a light-emitting unit, having two light-emitting elements, with one placed separately above the other, the light-emitting unit being disposed on the top of the main base body, and electrically connected to the power source part;
a pattern film, being transmittable, with surface having a grid pattern formed by laser etching, being housed inside a shell; and
a shell, being a hollow transparent shell, with one end having an opening, the outer surface of the shell having an ice crack pattern, and engaged to the main base body.

2. The structure of candle with faux ice crack pattern as claimed in claim 1, wherein the light-emitting unit further comprises a circuit board, forming electrical connection with the power source part, and the circuit board controls the two light-emitting elements.

3. The structure of candle with faux ice crack pattern as claimed in claim 1, wherein the shell comprises a hole at the top to allow the disposition of a shade.

4. The structure of candle with faux ice crack pattern as claimed in claim 1, wherein the main base body comprises a switch, with one end connected to the power source part, and the switch controls the ON and OFF of the light-emitting unit.
